(19) United States
(12) Patent Application Publication
(10) Pub. No.: US 2008/0096748 A1
(43) Pub. Date: Apr. 24, 2008

(54) REUSABLE PACKAGE, APPARATUS, AND METHOD

(76) Inventors: Donald F. Antonevich, Sylvania, OH (US); Wayne D. Meek, Rossford, OH (US)

Correspondence Address: FRASER CLEMENS MARTIN & MILLER LLC, 28366 KENSINGTON LANE, PERRYSBURG, OH, 43551, US

(21) Appl. No.: 11/876,341

(22) Filed: Oct. 22, 2007

Related U.S. Application Data
(60) Provisional application No. 60/853,596, filed on Oct. 23, 2006.

(51) Int. Cl. B31B 1/88; B31B 1/64; B31B 49/04; B65D 65/28

(52) U.S. Cl. 493/187; 383/208; 493/189; 493/267

(57) ABSTRACT

A package for the delivery of products of various sizes and shapes to customers, and apparatus and a method of producing the package are disclosed, wherein a sealing and a cutting process is employed to produce a customized shipping package from a first and a second web of material. The package is readily adaptable to be reused by the customer to return the product to the original source.

### CROSS-REFERENCE TO RELATED APPLICATION

This application claims the benefit of U.S. Provisional Patent Application Ser. No. 60/853,596 filed on Oct. 23, 2006.

### FIELD OF THE INVENTION

The present invention relates to packaging and more particularly to a package for the delivery of products of various sizes and shapes to customers for approval and use and readily adaptable to be reused by the customer to return the product to the original source.

### BACKGROUND OF THE INVENTION

Sheets of plastic materials are utilized in forming finished packages, such as pouches, for example, by various methods. In one such method, a heat formed seal or adhesive seal is formed to define the periphery of the final package. In the event that a rectangular package or pouch is desired, a rectangular film twice the desired length of the package is folded upon itself and the two parallel side edges perpendicular to the fold, are heat or adhesive sealed. Then the product to be packaged is inserted therein, and the remaining open side of the periphery is heat or adhesive sealed.

Another method for making a package or pouch is achieved by sealing on three sides the face-to-face film material; filling the formed open package with the product to be packaged therein; and then sealing the fourth side.

The problem encountered by the end user of the product within the pouch or package involves the reuse of the package to return the product due to size, color, style, etc. The packaging of the prior art has provided zipper-type closures, adhesive flap extensions, and hook and loop fasteners which have generally dealt with the reusable resealable feature of the package. However, the structures of the prior art have been expensive and time consuming to manufacture.

The typical pouch or package is produced in one of a number standard sizes. The sender of the product chooses a standard sized package that is large enough to contain the product to be shipped. The selected standard sized package is often larger than required to contain the product, increases the cost of packaging and shipping the product.

It would be desirable to produce a package of flexible sheet material which may be readily and economically produced in customized sizes and may be resealed to facilitate the reshipping of the package.

### SUMMARY OF THE INVENTION

Compatible and attuned with the present invention, a package of flexible sheet material which may be readily and economically produced in customized sizes and may be resealed to facilitate the reshipping of the package, has surprisingly been discovered.

In one embodiment, the package comprises a first sheet of flexible sheet material having parallel spaced apart side edges and parallel spaced apart end edges; a second sheet of flexible sheet material superposed on the first sheet having parallel spaced apart side edges and parallel spaced apart end edges, the respective side edges of the first and second sheets sealed together and the respective end edges of the first and second sheets sealed together to form a pouch having interior facing surfaces of sheet material; a line of perforations formed along at least one of the side edges and end edges of the first and second sheets to facilitate the separation of one of the sealed edges; and a selectably useable adhesive disposed on at least one of the facing surfaces of sheet material adjacent the line of perforations.

The apparatus for producing packages for differing sized objects comprises a first web of flexible material having spaced apart side edges for delivery along a path; a second web of flexible material having spaced apart side edges for delivery along the path in superposed relation with the first web; and sealing mechanism adapted to seal an object between facing surfaces of the first web and the second web forming a sealed package containing the object.

The invention also contemplates a method of producing the package that comprises the steps of providing a first web of flexible sheet material having parallel spaced apart side edges and a longitudinal axis; providing a second web of flexible sheet material in superposed relation with the first web having parallel spaced apart side edges in alignment with the respective side edges of the first web and a longitudinal axis; applying a selectably useable adhesive strip on at least one of the facing surfaces of the first and second webs; sealing the respective spaced apart side edges of the first and second webs; providing a weakening line extending generally parallel and adjacent to at least one of the sealed side edges; providing a control system having an electronic processor and at least one sensor in communication with the processor; detecting the critical dimensions of an object to be packaged with the at least one sensor; transmitting a signal representative of the critical dimensions from the sensor to the electronic processor effective to cause a sealing member to form a pair of spaced apart sealed ends in the first and second webs to form the sealed package containing the object.

### BRIEF DESCRIPTION OF THE DRAWINGS

The above, as well as other advantages of the invention, will become readily apparent to those skilled in the art from the following detailed description of an embodiment of the invention when considered in the light of the accompanying drawings, in which:

FIG. 1 is a schematic side elevational illustration of the apparatus for producing the package of the invention;

FIG. 2 is a schematic fragmentary top plan view of the apparatus shown in FIG. 1;

FIG. 3 is a schematic illustration of a control system in communication with selected components of the apparatus shown in FIGS. 1 and 2;

FIG. 4 is an enlarged schematic fragmentary perspective view of the apparatus shown in FIGS. 1 and 2 showing an object to be packaged entering a sealing mechanism of the apparatus;

FIG. 5 is an enlarged schematic fragmentary perspective view of the apparatus shown in FIGS. 1 and 2 showing a completed package containing the object exiting the sealing mechanism; and

FIG. 6 is a top plan view of the package produced by the apparatus shown in FIGS. 1 and 2, with a portion cut-away to more clearly illustrate the structure of the package.

### DETAILED DESCRIPTION OF THE PREFERRED EMBODIMENT

The following detailed description and appended drawings describe and illustrate an exemplary embodiment of the invention. The description and drawings serve to enable one skilled in the art to make and use the invention, and are not intended to limit the scope of the invention in any manner. In respect of the methods disclosed, the steps presented are exemplary in nature, and the order of the steps is not regarded as necessary or critical.

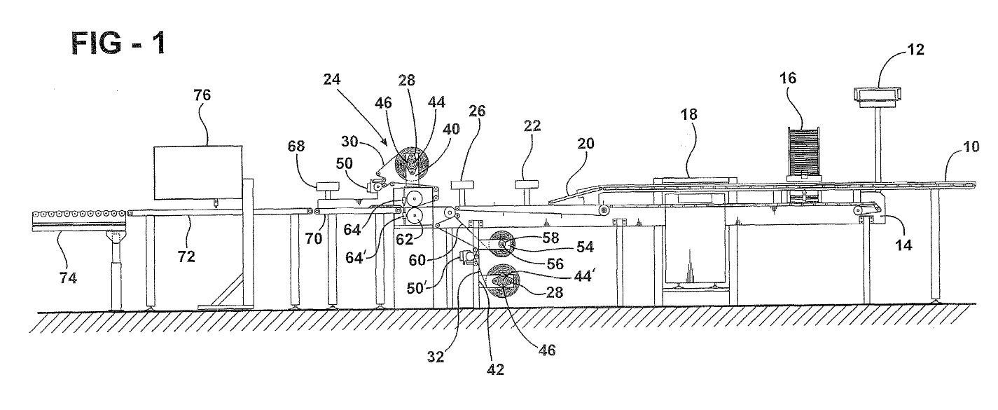

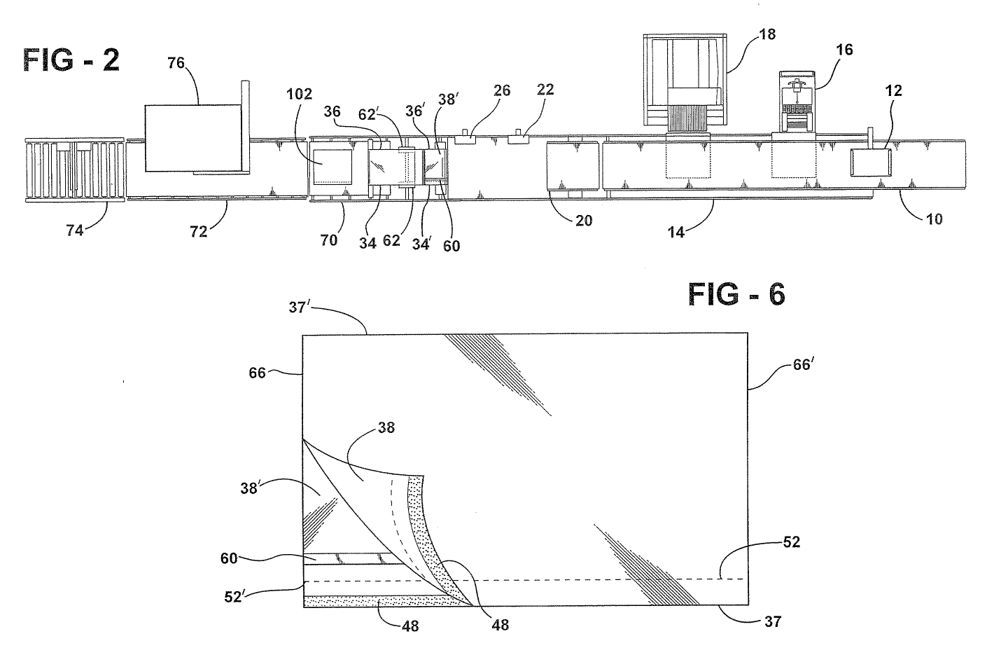

Referring to the drawings and in particular to FIGS. 1 and 2, there is illustrated an apparatus incorporating the features of the invention. The apparatus is adapted to produce a custom sized reusable and resealable package formed of flexible sheet material.

The apparatus includes a conveyor 10 for transporting an object to be packaged. A scanner 12 is attached to the conveyer 10 adapted to read a bar code disposed on the object identifying the object. Favorable results have been obtained employing such scanners as supplied by Accu-Sort of Telford, Pa.

A conveyor 14 is provided that is in longitudinal alignment with the conveyer 10. At least a portion of the conveyor 14 is disposed beneath the conveyer 10 having one end extending outwardly therefrom. At least one material dispensing apparatus 16 is attached to the conveyor 14. The material dispensing apparatus 16 is adapted to dispense selected pre-printed materials, such as a brochure or a return label, for example, to the conveyor 14. Favorable results have been obtained employing ST Series Droppers supplied by Thiele Tecnologies, Inc. (Streamfeader) of Minneapolis, Minn. A printer 18 is provided adjacent the conveyor 14. The printer 18 is adapted to print customized materials, such as an invoice, for example, and dispose the customized materials on the conveyor 14. The pre-printed materials and the customized materials are disposed on the conveyor 14 to form a single stack of printed materials desired to be included in the final sealed package.

The conveyor 10 includes an inclined member 20 disposed at the one end adjacent the conveyer 14. The inclined member 20 is adapted to place the object to be packaged on the conveyor 10 onto the conveyer 14 substantially centered on the stack of printed materials previously disposed on the conveyor 14.

An ultrasonic sensor 22 is provided adjacent the inclined member 20 and conveyor 14 to measure the combined height of the object and printed materials. It should be understood that other types of sensors can be used to measure the combined height of the object and printed materials. Additionally, it should be understood that the sensor 22 can be adapted to measure other critical dimensions of the object such as a width, for example.

The conveyor 14 terminates adjacent a receiving end of a sealing mechanism 24 adapted to enclose the object and the printed materials within a custom sized package. A photo electric sensor 26 is provided adjacent the receiving end of the sealing mechanism 24 to measure the length of the object along the longitudinal axis of the conveyor 14 as the object enters the sealing mechanism 24. It should be understood that other types of sensors can be used to measure the length of the object. Additionally, it should be understood that the sensor 26 can be adapted to measure other critical dimensions of the object such as a width, for example.

The sealing mechanism 24 includes a dispensing member 28 and a dispensing member 28′ adapted to supply a web of flexible sheet material 30 and a web of flexible sheet material 32, respectively, to form the final sealed package. The webs 30, 32 each have parallel spaced apart side edges 34, 36 and 34′, 36′ respectively. The dispensing member 28′ is adapted to dispense the web 32 in superposed relation to the web 30 having the parallel spaced apart side edges 34, 36 of the web 30 in alignment with the respective parallel spaced apart side edges 34′, 36′ of the web 32. The webs 30, 32 include surfaces 38, 38′, respectively, forming the inner facing surfaces in the sealed package.

The dispensing members 28, 28′ include support frames 40, 42 having shafts 44, 44′, respectively, suitably supported in journal bearings 46 disposed thereon. The shafts 44, 44′ are adapted to receive a roll of the webs 30, 32 of material, respectively, and rotatably dispense the material therefrom.

In the illustrated embodiment, the webs 30, 32 of material are a polyethylene laminate film. The material is a thermoplastic material to facilitate the formation of welded or heat sealed seams or edges between the webs 30, 32. The material includes a cohesive latex coating 48 disposed adjacent the side edges 34, 36 and 34′, 36′ to cold seal the respective side edges 34, 36 and 34′, 36′ of the and webs 30, 32 to form respective sealed side edges 37, 37′. Favorable results have been obtained using polyethylene films from Single Face Supply Co. of Aurora, Ill. It should be understood that other polymeric films could be employed, as well as other materials. Such other materials include bubble wrap, polyethylene, polyester, nylon, and laminates thereof, paper, foil, and foil laminates. The preferred laminate is comprised of a high density polyethylene layer and a low density polyethylene layer.

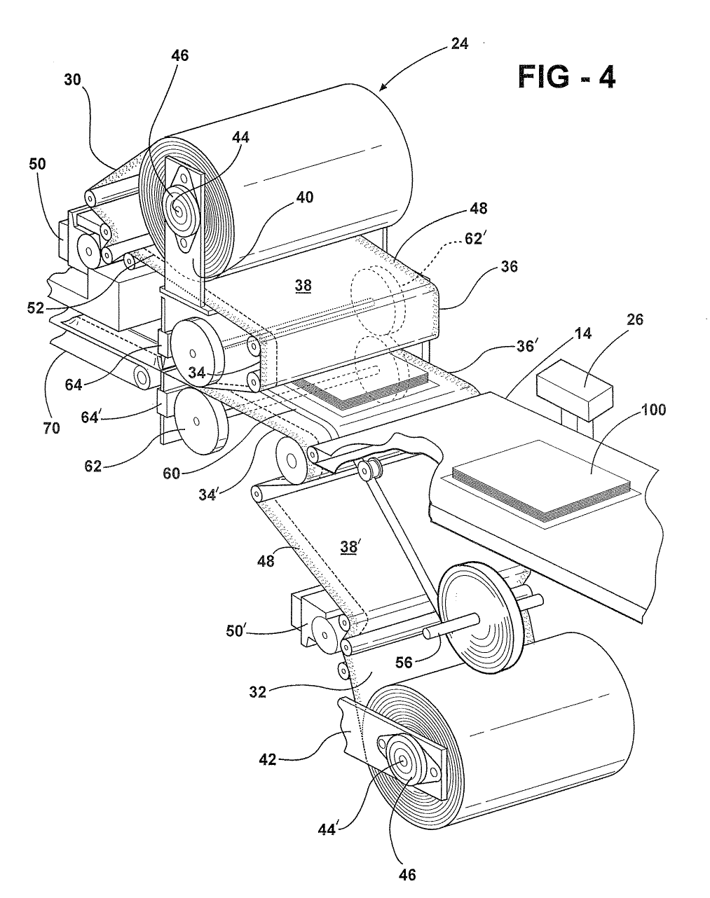

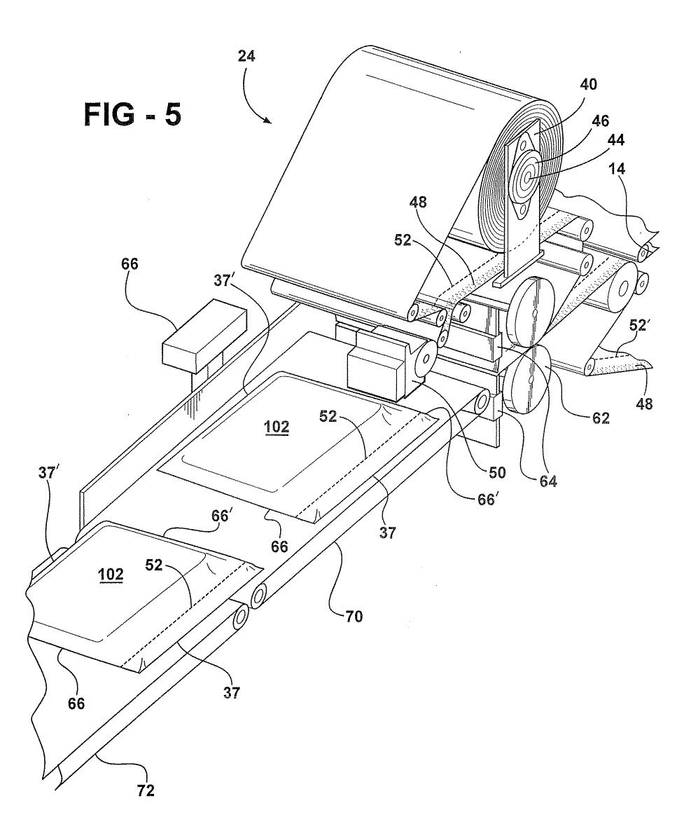

Perforators 50, 50′ are provided adjacent each dispensing member 28, 28′. The perforators 50, 50′ are adapted to form perforated lines 52, 52′, shown in FIGS. 4 and 5, in the webs 30, 32, respectively, parallel and adjacent to the side edges 34, 34′. It should be understood that the perforators 50, 50′ can be adapted to form the perforated lines 52, 52′ adjacent the side edges 36, 36′. The perforated lines 52, 52′ facilitate the removal of the sealed side edge 37 to form an opening for the package and provide access to the packaged object.

A dispensing member 54 is provided adjacent the dispensing member 28′. The dispensing member 54 includes a support shaft 56 suitably journaled in bearings 58 disposed on the support frame 42. The dispensing member 50 is adapted to dispense an adhesive 60 to the inner surface 38′ of the web 32 inboard of the perforated line 52′, and adjacent and parallel to the perforated line 52′. The adhesive 60 is adapted to facilitate the closing of the opening formed in the package upon removal of the sealed edge 37 at the perforated lines 52, 52′. In the illustrated embodiment, the adhesive 60 is a double sided pressure sensitive adhesive tape having one side covered with a readily removable protective strip and the opposite side adhered to the inner surface 38′ of the web 32. It should be understood that the dispensing member 50 can be adapted to apply the adhesive 60 to the inner surface 38 of the web 30 inboard of the perforated line 52. In the illustrated embodiment, the perforated lines 52, 52′ are in substantial alignment. It should be understood that line 52 can be offset from line 52′ and inboard of the adhesive 60 to facilitate the removal of a wider portion of the web 30 in respect of web 32 to form a flap in web 32 including the adhesive 60. The flap is adapted to facilitate access to the adhesive 60 and facilitate the closing of the opening formed in the package by folding the flap to place the adhesive 60 in contact with the outer surface of the web 30.

A side sealing member is provided to seal together the parallel spaced apart side edges 34, 36 of the web 30 with the respective parallel spaced apart side edges 34′, 36′ of the web 32 to form the respective sealed side edges 37, 37′. The side sealing member includes a pair of driven spaced apart resilient pinch rolls 62, 62′. Each pinch roll 62, 62′ is adapted to receive the side edges 34, 34′ and 36, 36′, respectively, of the webs 32, 34 causing the cohesive latex coating 48 to seal the respective side edges 34, 34′ and 36, 36′ of the webs 32, 34 to form the respective sealed side edges 37, 37′. Additionally, the pinch rolls 62, 62′ cooperate to pull the webs 30, 32 of material from the dispensing members 28, 28′ through the sealing mechanism 24. In the illustrated embodiment, the pinch rolls 62, 62′ are a pair of pneumatic tubes which frictionally engage the formed sealed side edges 37, 37′. It should be understood that the respective side edges 34, 34′ and 36, 36′ of the webs 30, 32 can be joined together by heat sealing or with an adhesive such as a double sided pressure sensitive adhesive tape, for example.

The sealing mechanism 24 includes an end sealing member disposed adjacent the side sealing member. The end sealing member includes an upper jaw 64 and a cooperating lower jaw 64′. The jaws 64, 64′ cooperate to press the facing inner surfaces 38, 38′ of the respective webs 30, 32 and form sealed end edges 66, 66′ in the final sealed package shown in FIG. 6. The jaws 64, 64′ provide heat energy to form a pair of spaced apart seals joining the web 30 to the web 32. The jaws 64, 64′ include a cutting blade (not shown) to sever the webs 30, 32 between the two heat seals to form the trailing sealed edge 66′ in one package and the leading sealed edge 66 in a following package. The sealed edges 66, 66′ can also be formed using a hot wire sealer which simultaneously joins the web 30 to the web 32 and severs the web 30 and the web 32 to form the trailing sealed edge 66′ in the one package and the leading sealed edge 66 in the following package. It should be understood that the sealed edges 66, 66′ can be formed using an adhesive such as a double sided pressure sensitive adhesive tape, for example. A sensor 68 is provided adjacent the jaws 64, 64′ and is adapted to detect the completed package as it exits the sealing mechanism 24.

A conveyor 70 is provided adjacent the jaws 64, 64′ to receive the completed package from the sealing mechanism 24 and transport the sealed package away from the sealing mechanism 24.

A conveyor 72 is provided to receive the completed package form the conveyor 70 and transport the package to a final accept-reject conveyor 74. The conveyor 72 may include a scale or weighing section (not shown) adapted to detect the weight of the completed package. Favorable results have been obtained employing the in-motion weighing conveyor 9481 Expresscheck® supplied by Mettler-Toledo, Inc. of Columbus, Ohio.

A labeling station 76 is provided adjacent the conveyor 72. The labeling station includes a printer adapted to print a shipping label for the completed package. An applicator attaches the shipping label to the completed package. The downstream end of the labeling station includes a scanner adapted to read the label to verify the attachment thereof. Favorable results have been obtained using label printer-applicator Model 5200 supplied by Webber Marking Systems, Inc. of Arlington Heights, Ill.

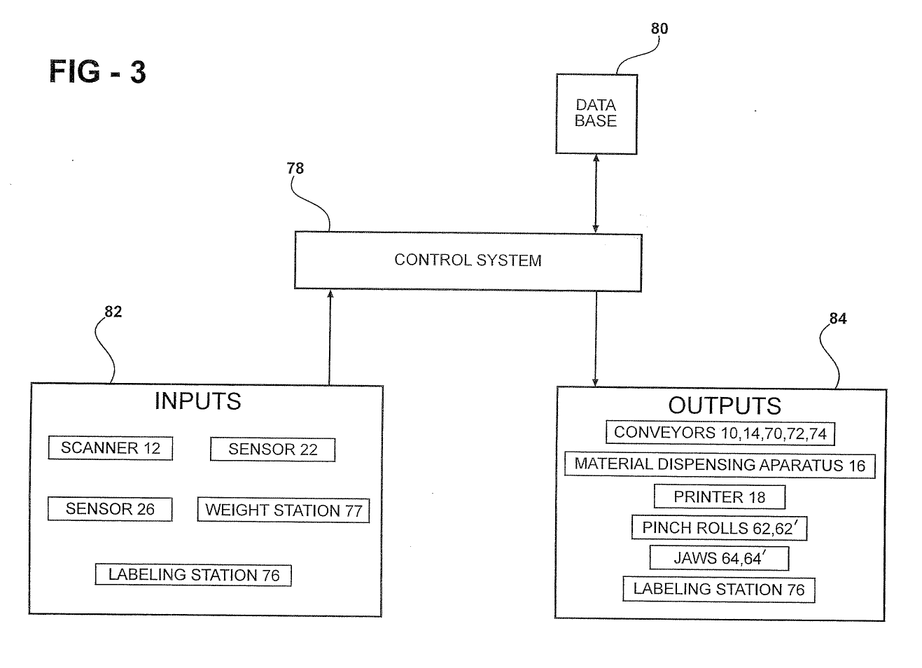

The apparatus includes a control system 78. A schematic drawing of the control system is shown in FIG. 3. The control system has an electronic processor adapted to control the operation of the apparatus. The control system 78 is in electrical communication with selected components of the apparatus. The control system 78 receives input signals 82 from selected components, namely; the scanner 12, ultrasonic sensor 22, photo electric sensor 26, the weigh station 77 (if included), and the scanner for the labeling station 76. The input signals are effective for the control system 78 to determine and send selected output signals 84 to control the operation of the conveyors 10, 14, 70, 72, 74; the material dispensing apparatus 16; the printer 18; the pinch rolls 62, 62′; the seal jaws 64, 64′; and the labeling station 76. Additionally, the control system 78 is in communication with an electronic data base 80 containing information related to each object to be packaged, such as the shipping address for each object, for example.

To form the sealed package containing the object and the printed materials, an operator places the object to be packaged on the conveyor 10. The object includes a bar code thereon having a unique identification reference associated with the object. The scanner 12 reads the bar code identification and transmits the bar code identification to the control system 78. The control system 78 then employs the bar code identification to obtain specific order and customer information for the object from the data base 80. The control system employs the obtained information from the data base 80 to dispense the required pre-printed materials from the material dispensing apparatus 16 to the conveyor. Selected information is also transmitted to the printer 18 effective for the printer 18 to print an invoice for the object. The control system 78 controls the placement of the printed materials on the conveyor 14 to coordinate the object and the printed materials coming together on the conveyor 14 in a single stack 100, as shown in FIG. 4.

The conveyor 14 transports the stack 100 to the sealing mechanism 24. The ultrasonic sensor 22 measures the height of the stack 100 as it is passes thereby. The sensor 22 transmits a signal representative of the measured stack height to the control system 78. The photo electric sensor 26 then measures the length of the stack 100 as it passes thereby and enters the sealing mechanism 24. The sensor 26 transmits a signal representative of the measured stack length to the control system 78. The control system 78 employs the height and length signals to determine the length of the webs 30, 32 required to form a package large enough to contain the stack 100. It should be understood that other critical dimensions can be measured and transmitted to the control system 78 as desired.

The webs 30, 32 are supplied to the sealing mechanism 24 from the respective rolls of web material received on the respective dispensing members 28, 28′. The dispensing members 28, 28′ direct the respective webs 30, 32 to a series of rollers to guide the webs 30, 32 to the pinch rolls 62, 62′ of the sealing mechanism 24. The stack 100 is received from the conveyor 14 between the webs 30, 32, as shown in FIG. 4.

As the webs 30, 32 are supplied to the sealing mechanism 26, the webs 30, 32 are caused to contact the respective perforators 50, 50′ forming the perforated lines 52, 52′ in the respective webs 30, 32. The perforated lines 52, 52′ are formed adjacent and substantially parallel to the side edge 34 of each web 30, 32. Additionally, the adhesive 60 is dispensed from the dispensing member 54 and disposed on the inner surface 38′ of the web 32. In the illustrated embodiment, the adhesive 60 is a double sided pressure sensitive adhesive tape having one side covered with a readily removable protective strip. The opposite side of the tape containing the exposed adhesive is pressed against the inner surface 38′ of the web 32.

The webs 30, 32 are then directed to the pinch rolls 62, 62′ in superposed relation having the respective inner surfaces 38, 38′ thereof facing each other. The respective side edges 34, 34′ and 36, 36′ of webs 30, 32 are received in the pinch rolls 62, 62′, respectively. The pinch rolls 62, 62′ cause the cohesive latex 48 disposed on the inner surfaces 38, 38′ adjacent the side edges 34, 34′ and 36, 36′ to contact and form the respective sealed side edges 37, 37′ of the completed package. The conveyor 12 causes the stack 100 to be received between the inner facing surfaces 38, 38′ of the and webs 30, 32 as the side edges 34, 34′ and 36, 36′ are received by the pinch rolls 62,62′. The stack 100 passes between the spaced apart pinch rolls 62, 62′ as the sealed side edges 37, 37′ are formed on each side of the stack 100. The control system causes the pinch rollers 62, 62′ to advance the webs 30, 32 with the stack 100 disposed therebetween through the sealing mechanism 24. The webs 30, 32 are advanced a length determined by the control system 78 employing the height and length measurements of the stack 100 provided by the ultrasonic sensor 22 and the photo electric sensor 26, respectively.

The webs 30, 32 then pass between the jaws 64, 64′. The control system 78 causes the forward motion of the webs 30, 32 to cease while the jaws 64, 64′ are closed, as shown in FIG. 5, to form a pair of parallel spaced apart sealed seams extending from the sealed side edge 37 to the sealed side edge 37′ substantially perpendicular thereto. The jaws 64, 64′ then sever the webs 32, 34 parallel to and between the pair of parallel spaced apart seems to form the trailing end edge 66′ in one package and the leading end edge 66 in a second package. The one package is then received on the conveyor 70 and transported away from the sealing mechanism 24. The control system then causes the jaws 64, 64 to open and the pinch rolls 62, 62′ to advance the webs 30, 32 substantially equivalent to the length detected by the control system 78 required to form the second package. The control system then causes the jaws 64, 64′ to close once again to form the trailing sealed end edge 66′ in the second package and the leading sealed end 66 in the next package. The process described is repeated on a substantially continuous basis to form custom sized packages for varying sized stacks 100 of objects and printed materials passing through the sealing mechanism 24.

The sealed package is then received on the conveyor 70 and transported to the conveyor 72. The conveyor 72 may include a scale (not shown) adapted to detect the weight of the package. The scale transmits a signal representative of the measured weight to the control system 78. The control system 78 can employ the weight signal to calculate the required postage or shipping cost to deliver the package to the customer. The package is then transported to the label station 76 where the control system 78 causes the shipping label to be printed and applied to the upward facing outer surface of the sealed package to form the completed shipping package 102 shown in FIG. 6. The label station 76 can employ the dimensional data of the package from the control system 78 to substantially center the shipping label on the completed package. The sensor of the label station 76 senses if the shipping label has been properly printed and attached to the package and sends a representative signal to the control system 78 that either indicates the label is or is not correctly printed and attached.

The conveyor 72 then transports the completed package 102 to the accept-reject conveyor 74. The control system 78 either causes the accept-reject conveyor 74 to pass the package 102 onward to be shipped to the customer or reject the package as a result of the sensor of the labeling station 76 detecting that the label is not correctly printed or attached.

The completed package 102, illustrated in FIG. 6, includes the webs 30, 32 joined together in superposed relation having the object and selected printed materials to be shipped sealed therebetween. The package 102 has the sealed side edges 37, 37′ and the sealed end edges 66, 66′. The customer tears the webs 30, 32 along the perforated lines 52, 52′ which removes the sealed edge 37 forming an opening into the interior of the package. The opening provides ready access to both the object enclosed in the package 104 and the adhesive 60.

However, it is a phenomenon of the present merchandising and sales of products over the internet, for example, that nearly sixty (60%) percent of the ordered products are returned to the sender for a myriad of reasons. In the event the product is to be returned, the product is replaced into the opened package, the protective strip is removed exposing the heretofore protected adhesive 60, and the inner surface 38 of the opened edge is pressed against the adhesive 60 to seal closed the opening. Alternatively, when the perforated lines 52, 52′ are offset to form the flap (not shown) in the web 32, the flap is folded and the adhesive 60 is pressed against the outer surface of the web 30 to seal closed the opening. The package is then ready to be returned.

The completed package 102 is produced at a minimized cost compared to the packages of the prior art. The size of the package 102 is customized to the object to be contained therein, which reduces the consumption of the material employed to form the package 102. Additionally, the apparatus and method disclosed herein, substantially automates the process of packaging the object. The automated process reduces the time required to package the object for shipping which reduces shipping costs and provides for a reduced delivery time.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A package comprising:
a first sheet of flexible sheet material having parallel spaced apart side edges and parallel spaced apart end edges;
a second sheet of flexible sheet material superposed on the first sheet having parallel spaced apart side edges and parallel spaced apart end edges, the respective side edges of the first and second sheets sealed together and the respective end edges of the first and second sheets sealed together to form a pouch having interior facing surfaces of sheet material;
a line of perforations formed along at least one of the side edges and end edges of the first and second sheets to facilitate the separation of one of the sealed edges; and
a selectably useable adhesive disposed on at least one of the facing surfaces of sheet material adjacent the line of perforations.

2. The package according to claim 1, wherein the material is a low-density polyethylene film.

3. The package according to claim 1, wherein the material is a polyethylene laminate film.

4. The package according to claim 1, wherein the material is a paper.

5. The package according to claim 1, including an adhesive disposed on the interior facing surfaces of the material along the respective side edges to seal together the respective side edges of the first and second sheets of material.

6. The package according to claim 5, wherein the adhesive is a latex cohesive.

7. The package according to claim 1, including at least one heat seal joining together at least one of the respective end edges of the first and second sheets of material.

8. The package according to claim 1, wherein the selectably useable adhesive is a pressure sensitive adhesive tape having one side adhered to one of the interior facing surfaces of the first and second sheets of material and an opposing side covered with a protective strip.

9. An apparatus for producing packages for differing sized objects comprising:
a first web of flexible material having spaced apart side edges for delivery along a path;
a second web of flexible material having spaced apart side edges for delivery along the path in superposed relation with the first web; and
sealing mechanism adapted to seal an object between facing surfaces of the first web and the second web forming a sealed package containing the object.

10. The apparatus according to claim 9, the sealing mechanism includes:
means to seal the respective side edges of the first web to the second web; and
means for forming a pair of spaced apart sealed end edges at required spaced apart intervals in the first and second webs to accommodate the object being packaged.

11. The apparatus according to claim 10, further including means to form a line of perforation extending generally parallel to the longitudinal axes of the first and second webs adjacent at least one of the sealed side edges.

12. The apparatus according to claim 11, further including a means for dispensing a selectively usable adhesive adjacent the line of perforation on at least one side of the facing surfaces of the first and second webs.

13. The apparatus according to claim 9, wherein the means to seal includes a control system having an electronic processor, and at least one sensor in communication with the processor, the control system adapted to detect the object and determine a length of the first and second webs required to form the sealed package containing the object.

14. The apparatus according to claim 13, further including means for disposing selected materials adjacent the object to be packaged.

15. The apparatus according to claim 13, further including a printer in communication with the control system and adapted to provide printed indicia to be packaged.

16. The apparatus according to claim 13, further including a weight scale in communication with the control system adapted to detect the weight of the sealed package and transmit a signal.

17. The apparatus according to claim 13, further including a label station in communication with the control system, the label station having:
a printer adapted to print a shipping label;
an applicator for attaching the shipping label to the package; and
a scanner adapted to verify the attachment of the shipping label to the package.

18. A method of producing a package comprising the steps of:
providing a first web of flexible sheet material having parallel spaced apart side edges and a longitudinal axis;
providing a second web of flexible sheet material in superposed relation with the first web having parallel spaced apart side edges in alignment with the respective side edges of the first web and a longitudinal axis;
applying a selectably useable adhesive strip on at least one of the facing surfaces of the first and second webs;
sealing the respective spaced apart side edges of the first and second webs;
providing a weakening line extending generally parallel and adjacent to at least one of the sealed side edges;
providing a control system having an electronic processor and at least one sensor in communication with the processor;
detecting the critical dimensions of an object to be packaged with the at least one sensor;
transmitting a signal representative of the critical dimensions from the sensor to the electronic processor effective to cause a sealing member to form a pair of spaced apart sealed ends in the first and second webs to form the sealed package containing the object.

19. The method according to claim 18 wherein the step of detecting the critical dimensions of the object includes detecting the height of the object.

20. The method according to claim 18 further providing the steps of:
providing a printer in communication with the processor adapted to print a shipping label for the package employing electronic data received from the processor;
providing an applicator for attaching the shipping label to an outer surface of the first web; and
providing a scanner adapted to verify the attachment of the shipping label to the outer surface of the first web.
